(19) United States
(12) Patent Application Publication
(10) Pub. No.: US 2020/0064767 A1
(43) Pub. Date: Feb. 27, 2020

(54) System and Usage-based Methods of Managing Replacements of Imaging Device Consumables

(71) Applicant: Lexmark International, Inc., Lexington, KY (US)

(72) Inventors: Ryan Luke Merin Daque, Labangon (PH); David Lynn Groce, Richmond, KY (US); Steven John Loboyko, Lexington, KY (US); David John Mickan, Lexington, KY (US); Kimberly Lisa Preston, Lexington, KY (US); Matthew Lee Rogers, Lexington, KY (US); Gregory Scott Tigges, Frankfort, KY (US); Jason Carl True, Lexington, KY (US)

(21) Appl. No.: 16/146,327

(22) Filed: Sep. 28, 2018

Related U.S. Application Data
(60) Provisional application No. 62/723,286, filed on Aug. 27, 2018.

(51) Int. Cl. G03G 15/00; H04N 1/00; G06F 9/54; G06F 3/12

(52) U.S. Cl. CPC G03G 15/556; H04N 1/00644; G06F 3/1273; G06F 3/1235; G06F 9/541

(57) ABSTRACT

A server including instructions to perform a method for managing replacement of a consumable in an imaging device, which includes, determining a remaining life of a consumable installed in the imaging device; determining an average number of pages printed in the imaging device during a predetermined period; identifying a number of days of use remaining based upon a rated life of the consumable, the remaining life of the consumable, and the average number of pages printed; and determining whether the number of days of use remaining is within a predefined floor range. Upon at least one of a determination that the number of days of use remaining is within a predetermined threshold and that the remaining life of the consumable is within a predefined floor range, an order for a replacement consumable for the imaging device is created and placed in an order fulfillment system.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

### 1. Technical Field

The present disclosure relates generally to replacing consumables in an imaging device, and, more particularly, to a system and methods of managing replacement of a consumable installed in the imaging device based upon usage of the imaging device.

### 2. Description of the Related Art

In a Managed Print Services (MPS) set-up, alerts from imaging devices are typically relied upon to create an order for replacement consumables, such as toner cartridges, imaging units, developers, maintenance kits, fusers, waste bottles, staples, etc. However, order creation may require significant resources to manually adjust or manage orders and/or to create complex business rules to ensure that false orders are not created.

Device alerts are commonly triggered when a specific percentage of remaining value in a consumable has been reached. For example, for a toner cartridge rated 10,000 pages, a device alert recommending the ordering of a replacement consumable may be displayed on an imaging device or otherwise sent to an administer when the printed pages count reaches 9000 pages (i.e., when 10% of rated toner cartridge life remains). Because of the difference in usage patterns of differing imaging devices, in one example, the imaging device with the re-order alert of 10% remaining may still have a month or more of printing left before the consumable is completely consumed or needs to be replaced whereas, in a second example, another imaging device with the same alert may have only about a week's worth of toner left for printing.

Existing systems which manage replacement of consumables typically rely on alerts (e.g., toner-level alerts) sent by imaging devices such that an order for a new consumable is created in response to the alerts. Since printer alerts may not be reflective of a frequency of utilization of the consumable in the imaging device, new consumables may either be delivered too early or too late.

Ideally, a new replacement consumable would be received “just in time”, i.e., a few days prior to the consumable reaching its rated life so that replacement may be made immediately. When a replacement consumable is ordered and delivered too soon (e.g., received weeks or months before the current consumable reaches its rated life), the consumable may be replaced before reaching its rated life, resulting in waste, or the replacement consumable may be potentially lost, thereby resulting in inventory issues or not being available for replacement when needed. When the replacement consumable is ordered and delivered too late, there is a risk of rendering the imaging device unusable (e.g., printing is prevented) for a period of time until the replacement consumable is received, thereby disrupting normal business operations. It is therefore desirable to have another method of managing the ordering of replacement consumables for the imaging device without heavy reliance on device alerts.

### SUMMARY

A method for managing replacement of a consumable in an imaging device communicatively connected to a server for performing the method of managing consumable replacement and a system for managing replacement of one or more removable supplies in an imaging device communicatively coupled to a data collection server are disclosed.

One example method for managing replacement of a consumable in an imaging device includes determining a remaining life of a consumable installed in an imaging device; determining an average number of pages printed by the imaging device during a predetermined period; identifying a number of days remaining prior to replacement of the consumable based upon a rated life of the consumable, the remaining life of the consumable and the average number of pages; determining whether the remaining life of the consumable is within a predefined floor range; and creating an order for a replacement consumable based upon at least one of a determination that the number of days remaining is within a predetermined threshold and a determination that the remaining life of the consumable is within the predefined floor range.

In one example embodiment, the order for the replacement consumable may be created upon the determination that the number of days remaining is within the predetermined threshold. The order may be created regardless of the determination that the remaining life of the consumable is within the predefined floor range. In another example embodiment, the order for the replacement consumable may be created upon the determination that the remaining life of the consumable is within the predefined floor range. In this example embodiment, the order may be created regardless of the determination that the number of days remaining is within the predetermined threshold. The disclosed example methods may be performed by a server communicatively connected to the imaging device. The server may be communicatively connected to an order fulfilment system and may include instructions to send a notification to the order fulfilment system upon a determination that an order is to be created for a replacement consumable.

Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example managed print services system which includes an imaging device having a consumable, a data collection server, and a customer relationship management system, according to one embodiment.

FIG. 2 is an example flowchart showing an example method of managing replacement of a consumable in the imaging device of FIG. 1.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the present disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or combinations of special purpose hardware and computer instructions.

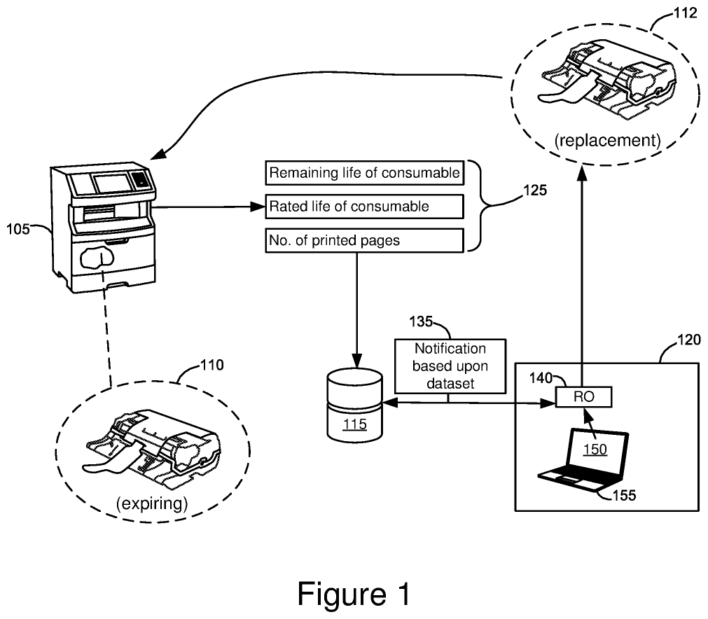

FIG. 1 shows one example MPS system 100 which includes an imaging device 105 having a consumable 110 installed therein, a data collection server 115, and a customer relationship management system (CRMS) 120. As shown in FIG. 1, imaging device 105 may be communicatively connected to data collection server 115, and data collection server 115 may be communicatively connected to CRMS 120. In another example embodiment, imaging device 105, data collection server 115, and CRMS 120 may be communicatively connected to each other via a common network (not shown). In the present disclosure, data collection server 115 may determine dataset 125. Dataset 125 may include a remaining life of consumable 110, a rated life of consumable 110, and an average number of pages printed in imaging device 105 during a predetermined period or usage level of imaging device 105. Data collection server 115 may include instructions to send a notification 135 to CRMS 120 based upon dataset 125. CRMS 120 may include instructions to generate, based upon notification 135, a replacement order (RO) 140 for delivering replacement consumable 112 to an owner, administrator or user of imaging device 105 for replacing consumable 110.

Imaging device 105 may be a single function printer or a multi-function machine (sometimes referred to as an all-in-one device) capable of printing, scanning, copying, e-mailing, faxing and/or other functions. Imaging device 105 may be a part of a plurality of imaging devices or fleet (not shown) of a customer and positioned for use by different users in MPS system 100. In some example embodiments, Imaging device 105 may include instructions to provide dataset 125 to data collection server 115. In other example embodiments, data collection server 115 may collect or retrieve dataset 125 from imaging device 105. Each datum in dataset 125 (remaining life of 110, rated life of 110, and average number of printed pages) may be provided to or collected by data collection server 115 individually or as a group or subgroup. Dataset 125 may be provided by imaging device 105 and/or collected by data collection server 115 on a periodic basis (e.g., hourly, daily, weekly, etc.) or upon request. Imaging device 105 may provide other data to data collection server 115 in addition to those mentioned to be part of dataset 125. For example, other data may be classifications of the printed pages (e.g., duplex, A3, A4, etc.), job length averages, a frequency of utilization of different features of imaging device 105 (e.g., printed 100 jobs during the day, scanned different documents 5 times, etc.) and/or other status conditions in imaging device 105 such as, for example, when an input tray bin is open while imaging device 105 is in use. While not shown, imaging device 105 may include a controller, a print engine, and a housing mechanism for housing consumable 110. Imaging device 105 may contain a plurality of types of consumable 110.

Consumable 110 may be representative of any replaceable unit or supply item in imaging device 105. For example, consumable 110 may be but is not limited to, a toner cartridge, an imaging unit, a maintenance kit, a toner waste bottle, a developer roll, a fuser or a staple cartridge. For example, consumable 110, when installed in imaging device 105, helps imaging device 105 execute an operation. A toner cartridge consumable 110 provides toner in imaging device 105 during printing. Consumable 110 may include a memory for storing information about consumable 110 and a processing circuitry for communicating with a controller of imaging device 105.

A rated life or page yield of consumable 110, which may be included in dataset 125, may refer to a predetermined life of consumable 110 while installed in imaging device 110. The rated life of consumable 110 may also be referred to as the “end of life” of consumable 110 since consumable 110 may be exhausted, depleted and/or not have any useful life remaining, thereby needing to be replaced in imaging device 105 when the rated life is reached. The rated life or page yield may be based upon a predetermined number of pages which may be printed in imaging device 105 while consumable 110 is in use. For example, a toner cartridge consumable 110 may have a rated life of 45,000 pages, imaging units a rated life of 100,000 pages, and maintenance kits a rated life of 300,000 pages. In other example embodiments, the rated life of each consumable 110 may be stored in a memory of imaging device 105. In yet other example embodiments, the rated life of each consumable 110 may be stored in a memory remote from imaging device 105, such as in a memory of data collection server 115. Since the rated life of consumable 110 is constant, data collection server 115 may determine the rated life of consumable 110 once.

Imaging device 105 may include instructions to determine a level of remaining life of consumable 110. The level of remaining life of consumable 110 may be measured relative to the rated life of consumable 110. Upon initial installation of consumable 110, the level of remaining life of consumable 110 may be equal to its rated life. The level of remaining life of consumable 110 in imaging device 105 may be expressed as a percentage. As operations are performed by imaging device 105, the level of remaining life of consumable 110 may decrease relative to its rated life. In other example embodiments, consumable 110 may report its level of remaining life to imaging device 105 instead of imaging device 105 performing the determination.

Data collection server 115 may be an example computing device or a group of computing devices. Data collection server 115 may be configured to receive data from imaging device 105. Data collection server 115 may include instructions to send a query to imaging device 105 to receive data from imaging device 105. Data received by data collection server 115 from imaging device 105 may include dataset 125. While shown as a group in FIG. 1, each datum in dataset 125 may be received separately and/or with another datum by data collection server 115 in other example embodiments.

Data collection server 115 may include a storage medium such as a database for storing the data collected from imaging device 105. Where imaging device 105 is part of a fleet of imaging devices, data collection server 115 may store data collected from each imaging device 105 and may treat data from each imaging device 105 independently. Data collection server 115 may also include a user interface (not shown). The user interface may allow an administrator or other user of MPS system 100 to modify a frequency of data collection in imaging device 105, to establish or reset connections with imaging device 105 and CRMS 120, to modify the stored information and the like. In other example embodiments, CRMS 120 may provide the user interface for accessing data collection server 115.

CRMS 120 may be an order fulfillment system including one or more software programs including instructions for, among other things, ordering and/or managing delivery of consumable 112 to an administrator or user of imaging device 105 having consumable 110. CRMS 120 may include a billing module (not shown) for charging the user or administrator of imaging device 105 on services rendered using imaging device 105 and/or on delivery of supplies (i.e., replacement consumable 112). CRMS 120 may further include an inventory module (not shown) for keeping track of consumables installed on imaging device 105 (e.g., consumable 110) and/or of other consumables delivered to the administrator or user of imaging device 105. CRMS 120 may include instructions to keep track of a condition of consumable 110 in imaging device 105. For example, CRMS 120 may be one of: Oracle® SIEBEL CRM, Microsoft® Dynamics 365, Salesforce® CRM, HubSpot® CRM and Zoho® CRM. In one example embodiment, an enterprise resource planning (ERP) system (not shown) for analyzing data from data collection server 115 may be integrated with CRMS 120. In another example embodiment, CRMS 120 may be communicatively connected to a separate ERP system. The ERP system may be, for example, SAP® or JD Edwards EnterpriseOne.

CRMS 120 may comprise an application 150. Application 150 may be executed in a computing device 155. Application 150 may be executed via a browsing application (not shown) in computing device 155. Application 150 may display one or more servicing orders for imaging device 105, such as replacement order 135. A service technician, administrator or other user may access application 150 via computing device 155 to determine whether replacement consumable 112 needs to be delivered to the administrator or user of imaging device 105 to replace consumable 110.

In one example embodiment of the present disclosure, data collection server 115 may include instructions to determine, using dataset 125 collected from imaging device 105, whether consumable 110 is approaching its rated life. Following a determination that, based upon dataset 125, consumable 110 is approaching its rated life and needs replacing in imaging device 105, data collection server 115 may send notification 135 to CRMS 120. CRMS 120 may then create replacement order 140 upon receipt of notification 135. Replacement order 140 may correspond to an order for replacing consumable 110 with replacement consumable 112), as will be discussed in greater detail below.

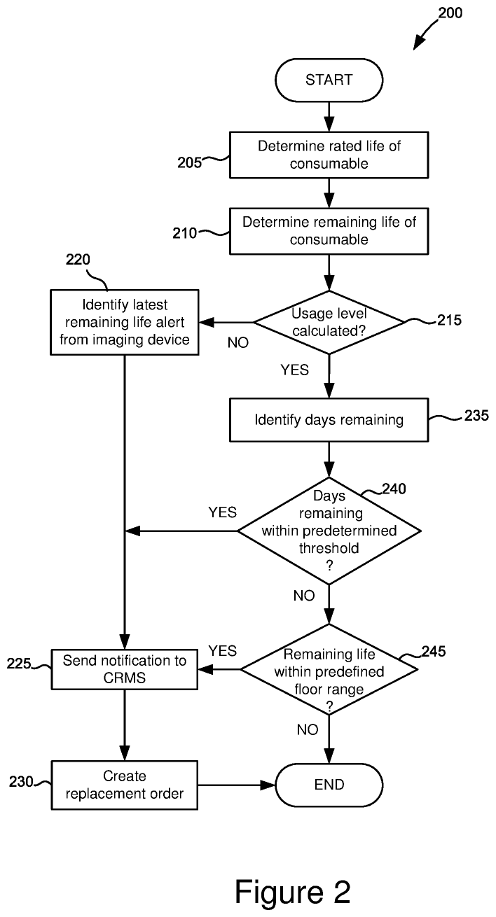

FIG. 2 is a flowchart showing one example method 200 for managing replacement of consumable 110 in imaging device 105 of FIG. 1. In some example embodiments, blocks 205-245 of example method 200 may be performed by data collection server 115 described in FIG. 1 every predetermined period. In other example embodiments, another computing device or system (not shown) communicatively connected to data collection server 115 may perform the actions described in example method 200. In still other example embodiments, data collection server 115 and CRMS 120 may be part of a single system that includes instructions to perform example method 200.

At block 205, data collection server 115 may determine a rated life of consumable 110. In one example embodiment, the rated life of consumable 110 may be stored in a memory of consumable 110. In another example embodiment, the rated life of consumable 110 may be stored in a memory of imaging device 105. The rated life of consumable 110 may be known to imaging device 105 upon installation of consumable 110 in imaging device 105. In still other example embodiments, the rated life of consumable 110 may be stored in data collection server 115 such that data collection server 115 need not determine this data. In yet other example embodiments, the rated life of consumable 110 may be stored in another storage medium (not shown) communicatively connected to imaging device 105 and/or data collection server 115.

At block 210, data collection server 115 may determine a remaining life of consumable 110. The remaining life may also refer to the reported level of life of consumable 110 in imaging device 105. The remaining life of consumable 110 may be part of dataset 125 as described above with respect to FIG. 1. In one example embodiment, imaging device 105 may include instructions to send the remaining life of consumable 110 to data collection server 115 at regular intervals. In another example embodiment, data collection server 115 may send a query to imaging device 105 to determine a remaining life of consumable 110 and imaging device 105 may send the remaining life of consumable 110 in response to the query.

The remaining life of consumable 110 may be expressed in percentage. In one example embodiment, the remaining life of consumable 110 may correspond to a percentage of toner remaining in consumable 110. In another example embodiment, the remaining life of consumable 110 may correspond to a percentage of a number of pages remaining to be printed by imaging device 105 using consumable 110 relative to its rated life determined at block 205. In still other example embodiments, the remaining life of consumable 110 may rely upon a toner coverage or darkness setting estimated based upon the average type of the documents printed by users of imaging device 105. For example, an imaging device that is commonly used to print heavily-lined drawings has relatively more toner coverage than an imaging device commonly used to print plain text. In one aspect, the toner coverage or darkness setting of imaging device 105 may vary depending on a type or model of imaging device 105. In another aspect, the toner coverage or darkness setting of imaging device 105 may vary based upon user-customized settings of imaging device 105.

At block 215, data collection server 115 may determine whether a usage level of imaging device 105 may be calculated. The usage level may correspond to an average number of pages printed in imaging device 105 within a predetermined period. For example, the average number of pages may be an average number of pages printed within a 2-week period, calculating the number of pages printed daily between today and two weeks prior.

In one example embodiment, determining whether the usage level data may be calculated may include determining whether a connection between imaging device 105 and data collection server 115 exists. In another example embodiment, determining whether the usage level may be calculated may include determining whether at least one of the rated life and the remaining life of consumable 110 is determined by data collection server 115 from imaging device 105. In other example embodiments, determining whether the usage level data may be calculated may include determining whether the data collection server 115 includes the instructions to determine the usage level in imaging device 105 based upon the rated life and the determined remaining life.

In performing block 215, data collection server 115 checks whether data allowing it to perform the proposed method in the present disclosure may be calculated. Upon a determination that the usage level data may not be calculated, data collection server 115 may proceed to perform a known alert-based method in creating replacement orders 140 starting at block 220. In relying upon percentage alerts from imaging device 105 when the usage level data may not be calculated by data collection server 115, an order for a replacement of consumable 110 may still be delivered to the customer.

At block 220, data collection server 115 may identify the latest alert received from imaging device 105 pertaining to a remaining life of consumable 110. The latest alert received may be the remaining life determined at block 210. At block 225, following identification of the alert, data collection server 115 may send notification 135 to CRMS 120, prompting CRMS 120 to create replacement order 140 (block 230). In one example embodiment of the present disclosure, the date of creation of replacement order 140 may be the same as the delivery date of consumable 112 to the administrator or user of imaging device 105. In another example embodiment, the date of creation of replacement order 140 may be a number of days prior to delivery of replacement consumable 112 to the administrator or user of imaging device 105.

At block 235, following a determination that the usage level may be calculated at block 215, data collection server 115 may identify a number of days remaining prior to rendering consumable 110 unusable in imaging device 105. The number of days remaining may be used by data collection server 115 to determine whether to send notification 135 to CRMS 120. The number of days remaining may be identified using the rated life of consumable 110 (block 205), remaining life of consumable 110 (block 210) and the usage level of imaging device 105 (block 215). The present disclosure uses the following equation in determining the number of days remaining:

days remaining=rated life of consumable*remaining life of consumable/usage level

For example, a rated life of an example consumable 110 may be predefined as 10,000 pages (block 205). Following a predetermined period of using consumable 110 (e.g., 14 days), data collection server 115 may determine that a remaining life of consumable 110 is at 15% (block 210). Data collection server 115 may also determine that an average of 100 pages have been printed by imaging device 105 during the 14-day period (i.e., usage level). Inserting these values to the above equation, data collection server 115 may determine that the number of days remaining is equal to 15 days, as calculated below:

15 days=10,000 pages*0.15 remaining life/100 average pages

At block 240, data collection server 115 may determine whether the number of days remaining identified at block 235 is less than or equal to a predetermined threshold. The predetermined threshold may be a number of days set to indicate that replacement order 140 should be created in CRMS 120 to replace consumable 110 in imaging device 105. The predetermined threshold may be set by a service technician, administrator or other user of CRMS 120. The predetermined threshold may be stored in data collection server 115 or in CRMS 120.

In one example embodiment, the predetermined threshold may be empirically determined based upon the number of days it takes CRMS 120 to deliver replacement consumable 112 to the administrator or other user of imaging device 105 and/or to prepare replacement consumable 112 for shipment. For example, it may take an average of seven (7) days for CRMS 120 to prepare replacement consumable 112 for shipment and delivery and an average of two (2) days for replacement consumable 112 to reach the user or administrator of imaging device 105. As such, the predetermined threshold may be set to nine (9) days.

In another example embodiment, the predetermined threshold may be modified in data collection server 115. For example, a user of CRMS 120 may set the predetermined threshold to another value in data collection server 115. In other example embodiments, data collection server 115 may include instructions to automatically adjust the predetermined threshold according to changes in a number of days spent by CRMS 120 in processing replacement order 140. For example, data collection server 115 may detect that a number of days spent by CRMS 120 in processing each replacement order 140 has decreased compared to a previous instance that a prior replacement order 140 was processed. Upon detection, data collection server 115 may deduct a difference between the number of days spent between the two instances to the predetermined threshold to come up with an adjusted threshold. Data collection server 115 may then use this adjusted threshold to determine whether to create replacement order 140.

As mentioned earlier in the present disclosure, alerts or the reported remaining life of consumable 110 may not be reflective of the actual time remaining before consumable 110 reaches its end of life in imaging device 105, i.e., how frequent consumable 110 is used in imaging device 105 may affect the accuracy of the reported remaining life. The present disclosure takes into consideration additional factors (besides comparison of the number of days remaining to a predetermined threshold) in determining whether consumable 110 is to be replaced in imaging device 105.

At block 245, following a determination that the number of days remaining is equal to or less than the predetermined threshold, data collection server 115 may further determine whether the remaining life of consumable 110 (block 210) in imaging device 105 is within a predefined floor range. The floor range may be stored in data collection server 115. The floor range may be set empirically based upon a type of consumable 110 (e.g., toner cartridge, imaging unit). The floor range may also differ depending upon a type or model of imaging device 105 since a level of accuracy of toner sensors in different imaging devices may vary. In one aspect, the floor range may be manually adjusted to correct reporting inaccuracies of percentage-based alerts. In another aspect, the floor range may be automatically determined, such as via machine learning, based upon a days remaining threshold (e.g., 16 days) and usage behavior within a predetermined period (e.g., 14 days). The order of performing the determination of the number of days remaining (block 240) and the determination of whether the remaining life is within the predetermined floor range (block 245) may be reversed or performed simultaneously in some example embodiments.

In one example embodiment, the floor range may be expressed as a percentage such as between about 2% to about 5%. In another example embodiment, the floor range may be expressed as a range of pages which may be printed by imaging device 105 using the remaining life of consumable 110. The predefined floor range may be one of, for example, 0-50 pages per day; 50-100 pages per day; 100-300 pages per day and 300 or more pages per day. In some example aspects, an amount of time or days that it takes for replacement consumable 112 to be delivered to the administrator or user of imaging device 105 may be considered in setting the floor range.

In some alternative example embodiments, following a determination that the number of days remaining is greater than the predetermined threshold, data collection server 115 may continue monitoring imaging device 105 for changes instead of performing block 245. In monitoring changes to imaging device 105, data collection server 115 may continue determining the remaining life of consumable 110 (block 210) and the usage level of imaging device 105 (block 215) until the number of days remaining identified (block 235) is again compared with the predetermined threshold (block 240) to determine whether replacement order 140 should be created.

At block 225, following a determination that the days remaining is within or less than or equal to the predetermined threshold or that the remaining life of consumable 110 has reached the predefined floor range, data collection server 115 may send notification 135 to CRMS 120, prompting CRMS 120 to create replacement order 140 at block 230. In one example embodiment, the date of creation of replacement order 140 may be the same as the delivery date of consumable 112 to the administrator or user of imaging device 105. In another example embodiment, the date of creation of replacement order 140 may be a number of days prior to delivery of replacement consumable 112 to the administrator or user of imaging device 105.

The present disclosure defines a delivery as being too early when about 25 to 297 days remain prior reaching rated life of consumable 110 and a delivery as being too late when about 0 to 4.9 days remain prior reaching rated life of consumable 110. Using example method 200, replacement consumable 112 may be delivered to the customer “just in time” or on time. The present disclosure defines “on time” delivery as between 5 to 25 days prior a rated life of the consumable. For purposes of discussion and employing example method 200 above, an administrator or user of imaging device 105 may receive consumable 112 (replacement for consumable 110) at about 13 days prior the rated life of consumable 110. Moving the date of the delivery of the consumable's replacement closer to its rated life or end of life not only allows full utilization of the consumable but also helps the customer make the most out of the consumables.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing replacement of a consumable in an imaging device, comprising:
determining, by a server communicatively connected to the imaging device, a remaining life of a consumable installed in the imaging device;
determining an average number of pages printed by the imaging device during a predetermined period;
identifying a number of days of use remaining for the consumable based upon its rated life, a remaining life of the consumable, and the average number of pages printed;
determining whether the remaining life of the consumable is within a predefined floor range; and
creating an order notification for a replacement consumable based upon at least one of a determination that the number of days of use remaining is one of less than or equal to the predetermined threshold and the determination that the remaining life is within the predefined floor range.

2. The method of claim 1, wherein the creating the order is performed upon the determination that the number of days of use remaining is less than or equal to the predetermined threshold regardless of the determination that the remaining life of the consumable is within the predefined floor range.

3. The method of claim 1, wherein the creating the order is performed upon the determination that the remaining life of the consumable is within the predefined floor range regardless of the determination that the number of days of use remaining is within the predetermined threshold.

4. The method of claim 1, further comprising sending the order notification to an order fulfillment system communicatively connected to the server for the creation of an order for the replacement consumable.

5. The method of claim 1, wherein the identifying the remaining life of the consumable comprises a querying of the imaging device by the server every predetermined period for the remaining life and the average number of pages printed during every predetermined period.

6. A server communicatively connected to an imaging device, the server including one or more instructions for managing replacement of a consumable installed on the imaging device, the one or more instructions to:
determine a remaining life of the consumable;
determine an average number of pages printed by the imaging device;
identify a number of days of use remaining for the consumable based upon its predetermined life, its remaining life, and the average number of pages printed;
determine whether the number of days of use remaining is within a predetermined threshold;
determine whether the remaining life of the consumable is within a predefined floor range; and
create an order for a replacement consumable based upon at least one of the determination that the number of days remaining is within the predetermined threshold and the determination that the remaining life is within the predefined floor range.

7. The server of claim 6, wherein the instruction to create the order for the replacement consumable is executed upon the determination that the number of days of use remaining is within the predetermined threshold regardless of the determination of whether the remaining life of the consumable is within the predefined floor range.

8. The server of claim 6, wherein the instruction to create the order for the replacement consumable is executed upon the determination that the remaining life of the consumable is within the predefined floor range regardless of the determination of whether the number of days remaining is within the predetermined threshold.

9. The server of claim 6, wherein the server further includes an instruction to send a notification to an order fulfilment system communicatively connected to the server for the creation of an order for the replacement consumable.

10. The server of claim 6, wherein the average number of pages printed is a running average of a number of pages printed by the imaging device within a predetermined period.

11. The server of claim 6, wherein the predetermined life of the consumable is stored in a memory of the consumable.

12. A system for managing replacement of one or more removable supplies in an imaging device, comprising:
an imaging device; and
a data collection server communicatively connected to the imaging device, wherein the data collection server includes instructions to:
determine a remaining life of a removable supply installed on the imaging device;
determine an average number of pages printed using the removable supply during a predetermined period;
calculate a number of days of use remaining for the removable supply based upon a rated life of the removable supply, a remaining life of the removable supply, and the average number of pages printed;
determine whether the remaining life is within a predetermined floor range; and
determine whether to create an order for a supply replacement for the imaging device based upon at least one of a determination that the number of days of use remaining is within a predetermined threshold and the determination that the remaining life is within the predetermined floor range.

13. The system of claim 12, wherein the data collection server further includes an instruction to create the order upon a determination that the number of days of use remaining is within the predetermined threshold regardless of whether the remaining life is within the predetermined floor range.

14. The system of claim 12, wherein the data collection server further includes an instruction to create the order upon the determination that the remaining life is within the predetermined floor range regardless of whether the number of days of use remaining is within the predetermined threshold.

15. The system of claim 12, wherein the system further includes a customer relationship management system communicatively coupled to the data collection server and wherein the data collection server sends a notification to the customer relationship management system instructing the customer relationship management system to create the order for the supply replacement.

16. The system of claim 12, wherein the predetermined period is a two-week period.

17. The system of claim 12, wherein the rated life of the removable supply is expressed by a number of pages printable by the imaging device while the supply is installed on the imaging device.

18. The system of claim 12, wherein the remaining life of the removable supply is based upon a percentage of toner remaining in the removable supply.

19. The system of claim 12, wherein the remaining life of the removable supply is based upon a percentage of a remaining number of pages printable in the imaging device relative to a predetermined number of pages.

20. The system of claim 12, wherein the remaining life of the removable supply is based upon an average amount of toner consumed by the imaging device during printing.
